(19) United States
(12) Patent Application Publication
(10) Pub. No.: US 2021/0126997 A1
(43) Pub. Date: Apr. 29, 2021

(54) System and Method for Providing In-Call Display

(71) Applicant: Daniel Nagy, Anaheim Hills, CA (US)

(72) Inventor: Daniel Nagy, Anaheim Hills, CA (US)

(21) Appl. No.: 17/139,037

(22) Filed: Dec. 31, 2020

Related U.S. Application Data
(63) Continuation-in-part of application No. 16/571,195, filed on Sep. 16, 2019.

(51) Int. Cl. H04M 1/27475; H04M 1/72469; H04M 1/253; H04M 1/64; H04M 3/493; G06F 3/0484; G06F 3/0482; G06F 3/0488

(52) U.S. Cl. CPC H04M 1/27475; H04M 1/72469; H04M 1/2535; G06F 3/04883; H04M 3/493; G06F 3/04842; G06F 3/0482; H04M 1/645

(57) ABSTRACT

A system and a method for providing in-call display is disclosed. A first interface wirelessly communicating to a second interface via a wireless communication channel. A call interface is configured to display said link upon clicking over said user interface. A media content interface is configured to display a plurality of options generated in real-time when said call is connected to said server interface. A first database consists of a plurality of modules for each service offered by said server interface, wherein each module from said first database comprises said plurality of options for said user interface to select. A second database is configured to receive said plurality of modules in real-time when said call is connected to said server interface, wherein said user interface is configured to select one or more of modules to according to a desired requirement of a user.

### CROSS-REFERENCE TO RELATED PATENT APPLICATION

This application is a continuation-in-part of U.S. application Ser. No. 16/571,195, filed on Sep. 16, 2019, titled “System and Method for Providing In-Call Display” which is incorporated by reference herein in its entirety.

### FIELD OF INVENTION

The present invention generally relates to a field of communication engineering and particularly to the field of telecommunication. The present invention specifically relates to a system and a method for providing in-call display to a plurality of target user from a service provider.

### BACKGROUND OF THE INVENTION

The telecommunication companies offer a number of services to a number of service providers or vendors. When a user places a phone call to a call center, the phone call may be answered by an auto-attendant of the call center. Interactive Voice Response (IVR) and auto attendants, otherwise known as automated telephone answering systems, have been known for many years. Their primary purpose is to automatically direct calls received by a company to the most appropriate location within the company. The Interactive Voice Response IVR or auto attendant prompts callers to make numerical or voice selections corresponding to the department or person to which they want to be connected. This reduces the number of operators or receptionists that are needed, providing substantial cost savings for the company.

The IVR or auto-attendant is an automated system that recites, over the phone to the user, a list of options along with respectively-associated keypad numbers (e.g., “Press 1 for customer service, 2 for billing”). The user selects a desired one of the listed options by saying a voice command or pressing the number on the keypad that is associated with the desired option. The IVR or auto-attendant then routes the call to an agent of the call center that is associated with the selected option. A number of systems have been developed for end-to-end conversation of a client or target user with a respective service provider. For example, U.S. Ser. No. 10/623,451B2 discloses a computer-implemented communication channel, server, methods, systems, device, apparatus, platform, application & service are disclosed for receiving by a server from a first user, a selection of a second user from a contact list, a request for initiating a call and a selection of one or more types of one or more applications, interfaces and media. In the event the second user accepts an initiated call within pre-set duration, start communication session and presenting said selected one or more applications, interfaces, media to first user and/or second user. Enabling the first user and/or the second user in real-time to access said presented application or interface or media and receiving by the server, a termination indication from the first user or the second user, the termination indication indicating the ending of the call and based on the termination indication, terminate the call or terminate said communication session.

Furthermore, U.S. Pat. No. 9,706,029B1 discloses a call processing system which receives a first message from a switch while the switch is processing a call for a calling party, wherein the first message is initiated at least partly in response to a firing of a call event trigger configured within a switch. The first message includes call signaling information, including the calling party's phone number. The calling party's phone number is stored in the call processing system. A communication channel is established over a network between the call processing system and a computer associated with the called party. A message is transmitted to the networked computer, the message including the calling party's phone number, wherein the calling party's phone number is intended to be displayed on the networked computer associated with the called party.

The systems and method as above disclosed a number of systems which are available in market does not provide a system in order to make an end-to-end conversation between a target user and a service provider with a real-time display or call interface for said target user to select a particular service by just clicking an option provided during said conversation.

### SUMMARY OF THE INVENTION

The present invention relates to systems and a method for providing an in-call display in order to make an end-to-end communication between a user and a service provider or vendor or between first user and a second user, in real time by displaying a number of options or services over a user's electronic gadget.

In an embodiment of the present invention a system for providing in-call display is disclosed comprising: a first interface wirelessly communicating to a server interface via a wireless communication channel, wherein said communication between said first user and said second user can be wired or wireless, wherein said first interface comprises a plurality of user interfaces configured to receive an embedded code from said server interface via said communication channel, wherein said code is configured to be in a form of a link, wherein said user interface is configured to click on said received link, wherein said user interface comprises a cellular electronic gadget or voice over internet protocol (VOIP) or any electronic means, configured to communicate to said server interface; a call interface coupled to said user interface, wherein said call interface is configured to display said link upon clicking over said user interface, wherein said call interface upon displaying said link, generates an option to communicate to said server interface via a wireless call; and a media content interface coupled to said user interface, wherein said media content interface is configured to display a plurality of options generated in real-time when said call is connected to said server interface, wherein said plurality of options consists of said list of services offered by said server interface

In another embodiment a speech translator module is communicatively coupled to said server interface and said user interface, wherein said translator module is configured to be activated when said call from said user interface is connected to said server interface, wherein said speech translator is configured to generate a plurality of speech enabled options in order to translate a speech enabled input, transmitted from said server interface to said user interface via said communication channel, into a user-friendly speech when said user interface selects an option from said plurality of speech enabled options in order to communicate to said server interface via said speech enabled input.

Another embodiment of the invention states a first database coupled to said server interface, wherein said first database consists of a plurality of modules for each service offered by said server interface, wherein each module from said first database comprises said plurality of options for said user interface to select; and a second database coupled to said user interface and wirelessly coupled to said first database of said server interface, wherein said second database is configured to receive said plurality of modules in real-time when said call is connected to said server interface, wherein said user interface is configured to select one or more of modules to according to a desired requirement of a user with said user interface, wherein upon selecting a module, said media content interface, over said call interface of said user interface, generates in real-time said list of services associated with said selected module, and said user is configured to select one or more services from said list as per desired requirement of said user.

Another embodiment of the present invention states a method of operating a system for providing in-call display. The method comprising steps: transmitting an embedded code or a link to a first interface from a second interface, wherein said first interface comprises a plurality of user interfaces communicating wirelessly to said second interface which comprises a server interface of a vendor, wherein said communication is made out via a wireless communication channel, wherein said user interface is configured to click on said embedded code or link; generating a call interface by clicking on said received link over said user interface, wherein said call interface is configured to display an option to communicate to said server interface via a wireless call; generating in real-time a plurality of options in order to make selection over a displayed content by clicking or gesturing over said call interface during said connected call, transmitted from said server interface to said user interface via said communication channel, into a user-friendly speech when said user interface selects an option from said plurality of speech enabled options in order to communicate to said server interface via said speech enabled input, wherein said translation of said speech enabled input is provided by a speech translator module which is communicatively coupled to said server interface and said user interface; displaying a plurality of options generated in real-time over a media content interface coupled to said user interface, when said call is connected to said server interface, wherein said plurality of options consists of said list of services offered by said server interface, wherein said server interface comprises a first database which consists of a plurality of modules for each service offered by said server interface, wherein each module from said first database comprises said plurality of options for said user interface to select; and selecting one or more of modules to according to a desired requirement of a user with said user interface, wherein upon selecting a module, said media content interface, over said call interface of said user interface, generates in real-time said list of services associated with said selected module, and said user is configured to select one or more services from said list as per desired requirement of said user, wherein said user interface comprises a second database wirelessly coupled to said first database of said server interface, wherein said second database is configured to receive said plurality of modules in real-time when said call is connected to said server interface.

To further clarify advantages and features of the present invention, a more particular description of the invention will be rendered by reference to specific embodiments thereof, which is illustrated in the appended drawings. It is appreciated that these drawings depict only typical embodiments of the invention and are therefore not to be considered limiting of its scope. The invention will be described and explained with additional specificity and detail with the accompanying drawings

### BRIEF DESCRIPTION OF FIGURES

These and other features, aspects, and advantages of the present invention will become better understood when the following detailed description is read with reference to the accompanying drawings in which like characters represent like parts throughout the drawings, wherein:

FIG. 1 illustrates a block diagram of a system for providing in-call display in accordance with an embodiment of the present invention.

FIG. 2 illustrates a flowchart of operations involved in a process for providing in-call display in accordance with an embodiment of the present invention.

FIG. 3 illustrates a block diagram of an example system for providing a smart phone interface for enhancing a call center's IVR or auto-attendant, in accordance with an embodiment of the present invention.

FIG. 4a-d illustrates placing of a phone call to a HOME DEPOT, connecting a phone call which system recognizes that the phone call will be answered by the auto-attendant that will recite audio options list, displaying a textual option list corresponding to the audio option list, and display of textual option list corresponding to the audio option list, in accordance with an embodiment of the present invention.

FIG. 5a-g illustrates user enters/finds phone number to the restaurant in accordance with an embodiment of the present invention.

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having benefit of the description herein.

### DETAILED DESCRIPTION

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present invention. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present invention will be described below in detail with reference to the accompanying drawings.

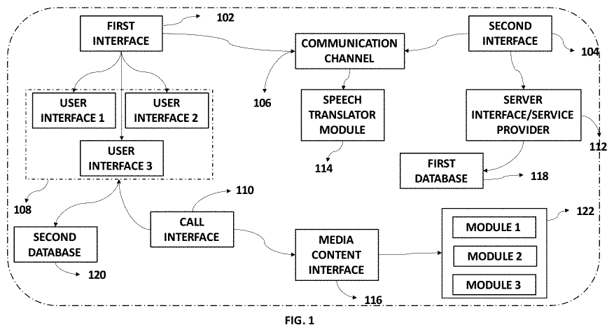

FIG. 1 illustrates a block diagram of a system for providing in-call display in accordance with an embodiment of the present invention. The system for providing in-call display includes a first interface (102) wirelessly communicating to a server interface (104, 112) via a wireless communication channel (106), wherein said first interface (102) comprises a plurality of user interfaces (108) configured to receive an embedded code from said server interface (104) via said communication channel (106), wherein said code is configured to be in a form of a link which can be voice activation link and can be visualized or hidden over said user interface, wherein said user interface (108) is configured to click on said received link, wherein said user interface (108) comprises a cellular electronic gadget or voice over internet protocol (VOIP) or any electronic means available configured to communicate to said server interface (104, 112).

A call interface (110) is coupled to said user interface (102, 108), wherein said call interface (110) is configured to display said link upon clicking over said user interface, wherein said call interface upon displaying said link, generates an option to communicate to said server interface (104, 112) via a wireless call.

A media content interface (116) is coupled to said user interface (108), wherein said media content interface (116) is configured to display a plurality of options generated in real-time when said call is connected to said server interface (104), wherein said plurality of options consists of said list of services offered by said server interface (104, 112).

A first database (118) is coupled to said server interface (112), wherein said first database (118) consists of a plurality of modules (122) for each service offered by said server interface (112), wherein each module (122) from said first database (118) comprises said plurality of options for said user interface (108) to select.

A second database (120) is coupled to said user interface (108) and wirelessly coupled to said first database (118) of said server interface (1120, wherein said second database (120) is configured to receive said plurality of modules (122) in real-time when said call is connected to said server interface (112), wherein said user interface (108) is configured to select one or more of modules (122) according to a desired requirement of a user with said user interface (108), wherein upon selecting a module, said media content interface (116), over said call interface (110) of said user interface (108), generates in real-time said list of services associated with said selected module (122), and said user is configured to select one or more services from said list as per desired requirement of said user.

The present invention in an embodiment may also include a speech translator module (114) is provided and is communicatively coupled to said server interface (104) and said user interface (108), wherein said translator module (114) is configured to be activated when said call from said user interface (108) is connected to said server interface (104), wherein said speech translator (114) is configured to generate a plurality of speech enabled options in order to translate a speech enabled input, transmitted from said server interface (104) to said user interface (108) via said communication channel (106), into a user-friendly speech when said user interface (108) selects an option from said plurality of speech enabled options in order to communicate to said server interface via said speech enabled input.

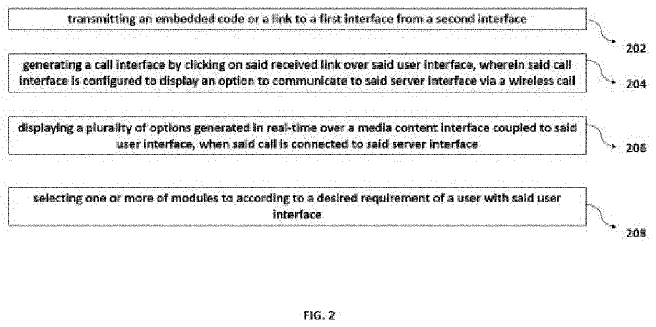

FIG. 2 illustrates a flowchart of operations involved in a process for providing in-call display in accordance with an embodiment of the present invention. The method of operating a system for providing in-call display includes steps as described follows.

The step (202) involves transmitting an embedded code or a link to a first interface from a second interface, wherein said first interface comprises a plurality of user interfaces communicating wirelessly to said second interface which comprises a server interface of a vendor, wherein said communication is made out via a wireless communication channel, wherein said user interface is configured to click on said embedded code or link.

The step (204) involves generating a call interface by clicking on said received link over said user interface, wherein said call interface is configured to display an option to communicate to said server interface via a wireless call.

The step (206) states displaying a plurality of options generated in real-time over a media content interface coupled to said user interface, when said call is connected to said server interface, wherein said plurality of options consists of said list of services offered by said server interface, wherein said server interface comprises a first database which consists of a plurality of modules for each service offered by said server interface, wherein each module from said first database comprises said plurality of options for said user interface to select.

The final step (208) describes selecting one or more of modules to according to a desired requirement of a user with said user interface, wherein upon selecting a module, said media content interface, over said call interface of said user interface, generates in real-time said list of services associated with said selected module, and said user is configured to select one or more services from said list as per desired requirement of said user, wherein said user interface comprises a second database wirelessly coupled to said first database of said server interface, wherein said second database is configured to receive said plurality of modules in real-time when said call is connected to said server interface.

The method can further include a step which involves generating in real-time a plurality of speech enabled options in order to translate a speech enabled input of said connected call, transmitted from said server interface to said user interface via said communication channel, into a user-friendly speech when said user interface selects an option from said plurality of speech enabled options in order to communicate to said server interface via said speech enabled input, wherein said translation of said speech enabled input is provided by a speech translator module which is communicatively coupled to said server interface and said user interface.

The present invention further states that a phone call can be executed via an embedded code in a link (common example is a phone number link like “714 888 9999” but can be any link like “Call now”) or the call can be voice activated where there may or may not be a link visible but the embedded code understands that the user wants to make a call; or it can be a gesture activated link, like hand or eye movements where again, there may or may not be a link visible but the embedded code knows to make the call—in other words, a user can open the call interface in various ways to initiate a phone call.

The call with in-call display can also be made from an app (The dialer app). The call can be made from user to user. The user is defined as either consumer or vendor. (Consumer to consumer C2C, consumer to business C2B or B2C, or business to business B2B.) Or call can be made from consumer to machine.

The Call can be connected via cellular tech, VOIP which are the two most common today or any other communication bridge. The call can be made from wireless device to wireless device, or to land line, or any sort of device that can receive a phone call.

The link opens a call interface. This may be on a mobile and/or nonmobile computing device (like a user's phone, on various smart hardware like a watch or bracelet or glasses, or projected from a device.) The link may open the interface in various forms including but not limited to a pop up in the same window as the link, in a new window, an app that is installed on the user's phone (ties back to original patent) or a projection.

The call interface communicates with backend database and/or call recipient's database to produce in-call user interface. The call interface can verify the identity of the caller using facial recognition, finger print, retinal recognition, voice recognition, hand or body gestures, or eye movements. (A good example is when a user calls a bank. Instead of telling the bank full name, address, security questions and the long list of things they ask to verify user identity, the user can avoid all of this by simply verifying an enable facial recognition. Once the identity is verified, the information is sent to the bank operator who is notified on their computer that the identity of the customer has been verified. None of the security questions will be needed.)

The customers on a live call can also pay with stored payment information when prompted for some sort of payment. So instead of getting out the credit card and telling the other end user the CC information, expiration date, and CSV code, they can simply select a stored form of payment, verify on screen and complete the transaction. Some sort of facial recognition or finger print or any other security measure may or may not be needed to complete the transaction.

In an example of a C2B call. The customer goes to a hotel's web page. There is a link that says Call Us, which the user clicks. The link opens the Dialer call interface and starts the call. The interface already shows the logo of the hotel and may be a special deal while the line rings and the customer wait for the hotel operator to answer. The hotel operator answers the call. The customer begins to talk to the hotel operator, asking to book a room. The hotel operator starts to enter into his computer the information given to him by the customer: how many people, what dates they stay for, etc. With each piece of information/data entered into the hotel's computer, the same information is mirrored on the customer's wireless phone so he can verify what the hotel operator has entered. When the customer agrees that the information is correct, the hotel operator searches for rates on his computer. The rates are displayed to the hotel operator and again, they are mirrored to the customer so he can see basically what the hotel operator sees. The customer or the hotel operator can select one of the rates on their screen. Once selected, the hotel operator then moves to choose a room for the customer on his computer. Again, the same image is displayed for the customer, with an image of a hotel room floor and various rooms that are marked as available to select. The customer or hotel operator can select which room they prefer. (The customer can select by clicking the room for example or they can tell the operator verbally which room that they see is the one they want and the hotel operator can make the same selection on their computer.) The hotel operator then requests for the customer to make the payment for the room by selecting the appropriate button on his computer. The customer can see and select a stored credit card on his computer and complete the purchase of the room. To complete the purchase an extra layer of security may or may not be requested (like facial recognition, etc.).

FIG. 3 illustrates a block diagram of an example system for providing a smart phone interface for enhancing a call center's IVR or auto-attendant, in accordance with an embodiment of the present invention. The system includes a call center 1 configured to receive an incoming phone call from a smart phone. The call center has different agents for performing respectively different types of functions for respectively different types of purposes of the incoming call.

The call center communicates with a smart phone through a front-end communication channel FE (front channel). The front channel includes a server 2 of the call-center, that is in communication, through a cellular and/or VOIP network 3, with a smart phone 4 of a user. When the user places a phone call to the call center, the call center server picks up the call and plays an auto-attendant message, which may be a prerecorded audio message that prompts the user to select a desired option (e.g., purpose of the call) using keys of the smart phone's telephone keypad. The auto-attendant's audio message might recite a list of options (option list), representing possible purposes of the call, along with associated keypad numbers (e.g., “Press 1 for customer service, 2 for billing, 3 for package-tracking”) The user selects the desired option by selecting (touching) the number (on the keypad) that corresponds to the desired option. The call center's server receives the user's key selection, possibly through DTMF tones, which indicates the user's selected option. The call center's server routes the call to the agent, of the call center, that is associated with the selected option.

The IVR's audio message might recite a list of options (option list), representing possible purposes of the call, along with associated key words (e.g., “Say Billing or press 1” or “Say Customer Service or press 2.”) The user selects the desired option by saying the key words (speaking) or selecting (touching) the number (on the keypad) that corresponds to the desired option. The call center's server receives the user's verbal selection, or key selection, possibly through DTMF tones, which indicates the user's selected option. The call center's server routes the call to the agent, of the call center, that is associated with the selected option.

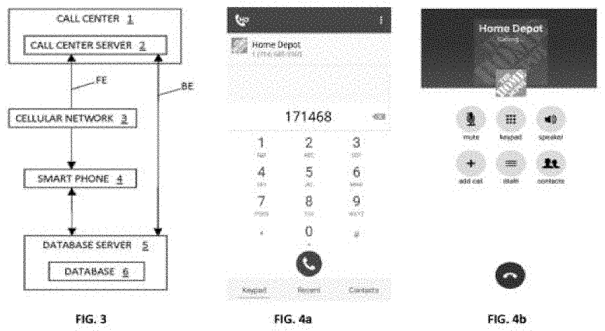

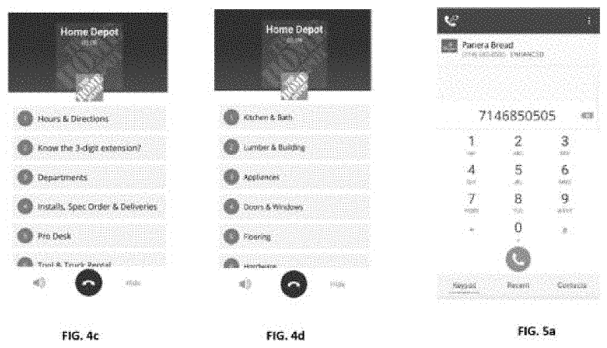

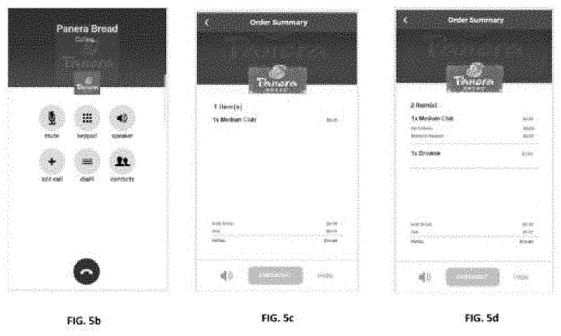

FIG. 4a-d illustrates placing of a phone call to a HOME DEPOT, connecting a phone call which system recognizes that the phone call will be answered by the auto-attendant that will recite audio options list, displaying a textual option list corresponding to the audio option list, and display of textual option list corresponding to the audio option list, in accordance with an embodiment of the present invention. The user starts connecting a phone call where the database recognizes the phone number called by the user and in turn, the database recognizes that the phone call will be answered by the auto-attendant that will recite audio options list.

A textual option list that is associated with the called phone number and corresponds to the call center's audio option list. The textual option list was retrieved by the database when the phone number was recognized, and sent by the database server to app for display to the user. In an exemplary situation where the auto attendant is currently saying, “Press 1 for Hours and directions; Press 2 if you know the 3-digit extension of the party you are trying to reach, etc.”

Displaying to the user via the link a textual option list retrieved by the database corresponding to the call center's audio option list where the user pushed “3 Departments.” The user's selection of “3 Departments” 1) sends a DTMF tone to the call center's server which prompts the auto attendant or IVR to recite the next menu list: “Press 1 for Kitchen and Bath; Press 2 for Lumber and Building, etc . . . ” and 2) simultaneously send the selection to the database, which then prompts the database server to send the corresponding textual option list to be displayed in the link for the user.

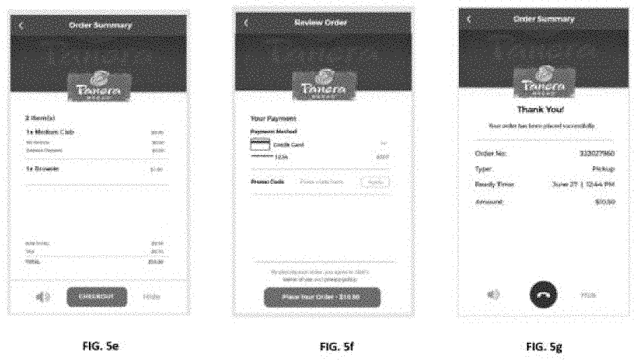

FIG. 5a-g illustrates user enters/finds phone number to the restaurant in accordance with an embodiment of the present invention. As explained above, data in the database includes each call center's phone number and may also include other data, like a restaurant's menu. This data might be obtained by a person (1) finding a tangible copy of the menu or finding a copy of the menu online, and then (2) manually entering the restaurant's menu into the database. The person might periodically (e.g., monthly) verify the restaurant's menu to check for any updates (changes) that the Restaurant might have made to the menu.

In another example, the database server and the Restaurant's server might be mutually configured (programmed) to communicate with each other through a back-end communication channel BE (back channel). The back channel might be implemented through API (Application Programming Interface). In that case, at least some of the data (call center phone numbers and Menu) in the database might be obtained from the restaurant's server itself via the back channel. This obviates the need for the menu and subsequent menu updates to be manually recorded and entered into the database.

While the user is communicating with the agent of the restaurant, the restaurant's server can send, to the link for display on the phone's screen, text and visual media that is relevant to the user's interaction with the agent. For example, if the user is placing an order with the agent, the displayed relevant text might include pictures of menu items available for order, or the details of the user's order for verification purposes. And if the user is making a payment through the agent, the displayed relevant text might include a request for payment. The relevant text, displayed during interaction with the agent, can be communicated by the restaurant's server to the link through the front channel, in the form of signals that are embedded within the phone call but that are imperceptible to the user. Alternatively, the relevant text can be communicated by the restaurant server to the link through the back channel (via the database server).

The restaurant server may, via the front-end channel or the back channel (database server) sends a request for payment to the user, which is displayed in the interface of the link.

The user, through the link interface, may pay for goods or services while communicating with the call center agent during a live phone call. The user, for example, may pay for their order during communication with the restaurant over a live phone call. The user indicates the payment method and initiates the payment in the link, which is then sent the payment processing company through an encrypted channel. Once the payment is approved or denied by the payment processing company, the results are sent to the database. The database server then sends confirmation of payment approval (or denial) to be displayed in the link for the user, and/or to the restaurant's server to be displayed for the restaurant agent.

The user may also make a payment in the link that uses a payment processing company that may be mutually configured with the restaurant's server.

The user, through the link, may pay for goods or services by manually entering the method of payment and relevant information into the link interface. For example, the user may enter credit card numbers, expirations dates, and a billing address. The user may also store various methods of payment to the database to obviate the need to manually enter payment methods for each request for payment. The user may then pay for goods and services by selecting stored methods of payment already added to the database under the user's profile.

As shown in FIG. 5a-g a call is made using the link, is connecting to the Restaurant, where the database recognizes the phone number called by the user. The database also recognizes that the phone call may result in the user ordering menu items found in the database under said restaurant and phone number.

The call is answered by restaurant agent. The user verbally tells the restaurant agent that he would like to order a “Medium Club” sandwich and the restaurant employee enters the menu item ordered into the restaurant's server. The restaurant server sends the menu item ordered “Medium Club” to the database, which is then sent by the database server to be displayed in the link on the phone screen for the user.

The user verbally tells the restaurant agent employee the rest of his order which might include a variety of items or modifications to items, such as “No Onions” on his Medium Club sandwich, add “Banana Peppers” to his Medium Club sandwich, and then he also ordered a “Brownie”. In each instance, and for each item or modification, the restaurant agent enters the menu item (or modification to the menu item) into the restaurant server, which sends the request to the database, which is then sent by the database server to be displayed in the link on the phone screen for the user.

The “Checkout” link at the bottom of the page has now lit up after the user has told the restaurant agent that his order is correct and he is ready to pay for the order. In such case, the restaurant agent enters a request for payment into the restaurant server, which sends the request to the database, which is then sent by the database server to be displayed in the link on the phone screen for the user. The request for payment is displayed to the user in the form of an activated and lit up “Checkout” link. The user now clicks the “Checkout” link to go to the next page, where he can begin the process of satisfying the request for payment by entering a credit card manually or selecting a credit card already stored in the database under the user's account.

The user pays for the order during a live phone call with the restaurant agent. The user, with the interface of the link, can choose a payment method already stored in the database or enter a manual payment method. The user can authorize the payment by clicking “Place Your Order” link, which sends the payment information through an encrypted channel to the payment processing company. The payment processing company in turn will send the approval or denial of the transaction to the database.

The user sees that his payment is confirmed and the order has been paid for. The confirmation of payment, which was received by the database from the payment processing company, is sent by the database server to be displayed in the link on the phone screen for the user.

Examples of other call centers might be online retailer, hotel, government agency, a manufacturer, and a brick-and-mortar retailer.

Examples of the placement of the phone call might be through the user dialing the call center's phone number using the smart phone's virtual keypad. Or by the user clicking on the call center's phone number that is displayed on a website the user is viewing on the smart phone.

The link might replace the phone's standard phone dial pad with the link's own custom dial pad or it can be outsourced so that any user may use the content of database to display visual content on their own native dialers.

While a specific embodiment has been shown and described, many variations are possible. With time, additional features may be employed. The particular shape or configuration of the platform or the interior configuration may be changed to suit the system or equipment with which it is used.

In an embodiment of the present invention which states that on the smart phone is a software application (link) for enhancing the IVR or audio auto-attendant message by displaying text that corresponds to the IVR or auto-attendant message. The link is in communication with a database server 5 that includes a database 6. The database stores a list of phone numbers of call centers. The database further stores, for each of the call centers, the options list of the respective call center's auto-attendant. When the call is being placed by the user, the link sends an indication of the dialed phone number to the database server. If the dialed phone number matches one of the call center phone numbers in the database, the database server sends, to the link, the matching call center's IVR or auto-attendant option list. When the IVR or auto-attendant recites the audio message containing the option list over the phone to the user, the link displays, on the phone's screen to the user, text corresponding to the option list.

The user may select from the option list displayed on the link by touching the visual list or verbalizing (saying) the selected option from the visual list. The user's selection is sent to the call center's server through the front-end channel which prompts the auto attendant or IVR to respond with the next step in the programmed option list. In parallel, the user's selection from the visual option displayed in the link is also sent to the database. Each time the user makes a selection from the visual option list displayed in the link, the link sends the selection to the database, which is captured by the database, then the database server sends the next step in the programmed option list to the link for display on the phone to the user.

The user may make their selection by pushing the visual option or saying the key words displayed in the visual option. The user may also communicate with the call center server in other methods like biometric recognition (e.g., voice imprint recognition or fingerprint verification) or movement recognition (e.g., hand wave or blinking). Alternatively, the user can communicate with the call center's server through the back channel (via the database server).

The textual option list might be completely displayed before the audio option list is completely recited. This enables the user to understand all the options and select the desired option even before that option has been verbally recited by the IVR or auto-attendant. Additionally, the user might consider reading the option list to be simpler to do than listening to the option list. The user may select from the visual option list before, during, or after that option has been verbally recited by the IVR or auto-attendant.

As explained above in FIG. 3, data in the database includes each call center's phone number and option list. This data might be obtained by a person (1) looking up phone numbers of different call centers, (2) calling each call center and manually recording the respective call center's option list, and then (3) manually entering the call center's name, phone number, and option list into the database. The person might periodically (e.g., monthly) phone the call center again to check for any updates (changes) that the call center might have made to the option list.

The data in the database might further include, for each call center's auto-attendant, an indication of amount of time (how long to wait) before a key selection may be entered (for that key entry to be recognized by the auto-attendant), so that the link will postpone displaying the waitlist for that amount of time.

In another example, the database server and the call center's server might be mutually configured (programmed) to communicate with each other through a back-end communication channel BE (back channel). The back channel might be implemented through API (Application Programming Interface). In that case, at least some of the data (call center phone numbers and option lists) in the database might be obtained from the call center's server itself via the back channel. This obviates the need for the option list and subsequent option-list updates to be manually recorded and entered into the database.

In another example, the vendor's server and the link are mutually configured (programmed) to communicate with each other by embedding data through the front channel, in the form of data signals that are embedded within the cellular and/or VOIP signal but that are imperceptible to the user. In this example, the option list can be communicated by the call center's server to the link through the front end cellular and/or VOIP signal. This obviates the need for the option list and subsequent updates to be manually recorded and entered into the database.

In another example, the vendor may choose to use the database to store the option list and the auto-attendant's audio message and the backend server would deliver both.

Before or after the user selects the option, or while the user is on hold waiting to be connected to the agent (of the call center), the call center's server can send, to the link for display on the phone's screen, additional text (e.g., advertisements). The additional text can be communicated by the call center's server to the link through the front channel, in the form of signals that are embedded within the cellular and/or VOIP signal but that are imperceptible to the user. Alternatively, the additional text can be communicated by the call center's server to the link through the back channel (via the database server). The call center may add said additional text to the database manually or via computer automation. The call center agent may queue the call center server's server for the additional text, which is then sent to the database to retrieve the specific text requested, which is then received by the database and then delivered by the database server to the link for display on the phone screen.

The present invention further states that said server interface comprises a vendor or service provider with each service stored as said plurality of modules in said first database. The server interface when receiving said call from said user interface transmits said link, with embedded code or number which includes said plurality of modules as services offered, from said first database to said second database of said user interface in real-time.

The server interface is configured to communicate with said plurality of user interfaces in real-time. Said link is clicked over said user interface, said call interface is configured to be opened over a new window of said user interface.

The speech translator module is configured to translate when said user clicks over said one or more speech enabled options in real-time, wherein said plurality of speech enabled options are repeated once said user does not click on one or more speech enabled options.

The call interface opened by clicking said link comprises a pop up in a same window as of said link over said user interface.

The system further comprises a video interface module coupled to said user interface, wherein said video interface module is generated when said link is clicked over said user interface, wherein when said video interface module is displayed over a new window of said user interface, said main server starts communicating to said user over a video call, wherein said server transmits said plurality of modules over said video interface in order to select one or more modules accordingly.

The system further comprises a unique phone number assigned to said user, wherein said unique phone number is not a wireless phone number of the user and said unique phone number is not a wireline phone number of the user; and a user contact data store is accessed through said link, wherein said store comprises a list of contact records editable by said user via said user interface of at least one internet-connected computing device of the user.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

What is claimed is:

1. A system for providing in-call display comprising:
a first interface wirelessly communicating to a second interface via a wireless communication channel, wherein said first interface comprises a plurality of user interfaces configured to execute a call via an embedded code in a link to said server interface via said communication channel, wherein second interface comprises a server interface of a service provider, wherein said call is configured to be voice activated in which said link is configured to be visualized and/or hidden and said embedded code automatically activates said call, wherein said user interface is configured to click on said received link, wherein said user interface comprises a cellular electronic gadget or voice over internet protocol (VOIP) configured to communicate to said server interface;
a call interface coupled to said user interface, wherein said call interface is configured to display said link upon clicking over said user interface, wherein said call interface upon displaying said link, generates an option to communicate to said server interface via a wireless call;
a media content interface coupled to said user interface, wherein said media content interface is configured to display a plurality of options generated in real-time when said call is connected to said server interface, wherein said plurality of options consists of said list of services offered by said server interface;
a first database coupled to said server interface, wherein said first database consists of a plurality of modules for each service offered by said server interface, wherein each module from said first database comprises said plurality of options for said user interface to select;
a second database coupled to said user interface and wirelessly coupled to said first database of said server interface, wherein said second database is configured to receive said plurality of modules in real-time when said call is connected to said server interface, wherein said user interface is configured to select one or more of modules to according to a desired requirement of a user with said user interface, wherein upon selecting a module, said media content interface, over said call interface of said user interface, generates in real-time said list of services associated with said selected module, and said user is configured to select one or more services from said list as per desired requirement of said user.

2. The system for providing in-call display as claimed in claim 1, wherein said user interface activates said call via said embedded code through a gesture activated link, wherein said user is configured to verify facial recognition details once said call is activated or connected towards said user interface.

3. The system for providing in-call display as claimed in claim 1, wherein said server interface comprises a vendor or service provider with each service stored as said plurality of modules in said first database.

4. The system for providing in-call display as claimed in claim 1, wherein said server interface when receiving said call from said user interface transmits said link, with embedded code or number which includes said plurality of modules as services offered, from said first database to said second database of said user interface in real-time.

5. The system for providing in-call display as claimed in claim 1, wherein said server interface is configured to communicate with said plurality of user interfaces in real-time.

6. A system for providing in-call display comprising:
a first interface wirelessly communicating to a second interface via a wireless communication channel, wherein said first interface comprises a plurality of user interfaces configured to execute a call via an embedded code in a link to said server interface via said communication channel, wherein second interface comprises a server interface of a service provider, wherein said call is configured to be voice activated in which said link is configured to be visualized and/or hidden and said embedded code automatically activates said call, wherein said user interface is configured to click on said received link, wherein said user interface comprises a cellular electronic gadget or voice over internet protocol (VOIP) configured to communicate to said server interface;
a call interface coupled to said user interface, wherein said call interface is configured to display said link upon clicking over said user interface, wherein said call interface upon displaying said link, generates an option to communicate to said server interface via a wireless call;
a media content interface coupled to said user interface, wherein said media content interface is configured to display a plurality of options generated in real-time when said call is connected to said server interface, wherein said plurality of options consists of said list of services offered by said server interface;
a first database coupled to said server interface, wherein said first database consists of a plurality of modules for each service offered by said server interface, wherein each module from said first database comprises said plurality of options for said user interface to select; and
a second database coupled to said user interface and wirelessly coupled to said first database of said server interface, wherein said second database is configured to receive said plurality of modules in real-time when said call is connected to said server interface, wherein said user interface is configured to select one or more of modules according to a desired requirement of a user with said user interface, wherein upon selecting a module, said media content interface, over said call interface of said user interface, generates in real-time said list of services associated with said selected module, and said user is configured to select one or more services from said list as per desired requirement of said user.

7. The system for providing in-call display as claimed in claim 5, wherein said system further comprises:
a speech translator module communicatively coupled to said server interface and said user interface, wherein said translator module is configured to be activated when said call from said user interface is connected to said server interface, wherein said speech translator is configured to generate a plurality of speech enabled options in order to translate a speech enabled input, transmitted from said server interface to said user interface via said communication channel, into a user-friendly speech when said user interface selects an option from said plurality of speech enabled options in order to communicate to said server interface via said speech enabled input;

7. The system for providing in-call display as claimed in claim 5, wherein when said link is clicked over said user interface, said call interface is configured to be opened over a new window of said user interface.

8. The system for providing in-call display as claimed in claim 5, wherein said speech translator module is configured to translate when said user clicks over said one or more speech enabled options in real-time, wherein said plurality of speech enabled options are repeated once said user does not click on one or more speech enabled options.

9. The system for providing in-call display as claimed in claim 5, wherein said call interface opened by clicking said link comprises a pop up in a same window as of said link over said user interface.

10. The system for providing in-call display as claimed in claim 5, wherein said system further comprises:
a video interface module coupled to said user interface, wherein said video interface module is generated when said link is clicked over said user interface, wherein when said video interface module is displayed over a new window of said user interface, said main server starts communicating to said user over a video call, wherein said server transmits said plurality of modules over said video interface in order to select one or more modules accordingly.

11. The system for providing in-call display as claimed in claim 5, wherein said system further comprises:
a unique phone number assigned to said user, wherein said unique phone number is not a wireless phone number of the user and said unique phone number is not a wireline phone number of the user; and
a user contact data store is accessed through said link, wherein said store comprises a list of contact records editable by said user via said user interface of at least one internet-connected computing device of the user.

12. A method of operating a system for providing in-call display, the method comprising steps:
transmitting an embedded code or a link to a first interface from a second interface, wherein said first interface comprises a plurality of user interfaces communicating wirelessly to said second interface which comprises a server interface of a vendor, wherein said communication is made out via a wireless communication channel, wherein said user interface is configured to click on said embedded code or link;
generating a call interface by clicking on said received link over said user interface, wherein said call interface is configured to display an option to communicate to said server interface via a wireless call;
displaying a plurality of options generated in real-time over a media content interface coupled to said user interface, when said call is connected to said server interface, wherein said plurality of options consists of said list of services offered by said server interface, wherein said server interface comprises a first database which consists of a plurality of modules for each service offered by said server interface, wherein each module from said first database comprises said plurality of options for said user interface to select; and
selecting one or more of modules to according to a desired requirement of a user with said user interface, wherein upon selecting a module, said media content interface, over said call interface of said user interface, generates in real-time said list of services associated with said selected module, and said user is configured to select one or more services from said list as per desired requirement of said user, wherein said user interface comprises a second database wirelessly coupled to said first database of said server interface, wherein said second database is configured to receive said plurality of modules in real-time when said call is connected to said server interface.

13. The method as claimed in claim 12, wherein said method further comprises:
generating in real-time a plurality of speech enabled options in order to translate a speech enabled input of said connected call, transmitted from said server interface to said user interface via said communication channel, into a user-friendly speech when said user interface selects an option from said plurality of speech enabled options in order to communicate to said server interface via said speech enabled input, wherein said translation of said speech enabled input is provided by a speech translator module which is communicatively coupled to said server interface and said user interface;
